(19) United States
(12) Patent Application Publication
(10) Pub. No.: US 2021/0293351 A1
(43) Pub. Date: Sep. 23, 2021

(54) TANK LEVEL SENSOR

(71) Applicant: WALNAB PTY LTD, New South Wales (AU)

(72) Inventors: Emil-Dan Dragomirescu, New South Wales (AU); Adam Peattie, New South Wales (AU)

(21) Appl. No.: 16/332,710

(22) PCT Filed: Sep. 22, 2017
(86) PCT No.: PCT/AU2017/051039

§ 371 Date: Mar. 12, 2019

(30) Foreign Application Priority Data
Sep. 23, 2016 (AU) 2016903857

(51) Int. Cl. F16K 31/34; B60K 15/035; F16K 21/18

(52) U.S. Cl. CPC F16K 31/34; B60K 2015/03576; F16K 21/18; B60K 15/03519

(57) ABSTRACT

The present invention relates generally to a tank overfill protection system (10) designed to be installed in a tank (12). The tank overfill protection system (10) comprises a tank level sensor (14) operatively coupled to a flow control valve assembly (16). The flow control valve assembly (16) is connected to the level sensor (14) via a pilot line (18) which contains a bleed fluid for controlling closure of the flow control valve assembly (16). The tank level sensor (14) comprises a valve body (20), a pilot valve (22) mounted to the valve body (20), and a pilot valve actuator (24) operatively coupled to the pilot valve (22) for its opening and closure. The pilot valve actuator (24) includes a balance member (26) arranged to cooperate with actuator biasing means in the form of a pilot compression spring (28). The balance member (26) is in the form of a counterbalance and has a specific gravity relative to liquid or fuel within the tank (12) so that at least part submersion of the balance member (26) under the influence of the pilot compression spring (28) provides movement of the balance member (26) and closure of the pilot valve (22). This closure of the pilot valve (22) substantially closes and subsequently pressurises the bleed fluid in the pilot line (18) for closure of the flow control valve assembly (16).

### TECHNICAL FIELD

The present invention relates broadly to a tank level sensor and relates particularly, although not exclusively, to an integrated tank level sensor and venting assembly. The invention also relates generally to a tank overfill protection system and a refilling system for multiple tanks.

### BACKGROUND OF INVENTION

In conventional tank refuelling systems, a flow control valve mounted within the tank refilling line is automatically controlled for closure at a safe fill level via a float valve. The float valve is typically mounted to the ceiling of the tank and connects to the flow control valve via a pilot line. The pilot line contains bleed fluid, generally fuel, bled from the flow control valve to the float valve. Below the safe fill level, the bleed fluid is discharged into the tank via a pilot inlet valve associated with the float valve. The float valve includes a float connected to the pilot valve and designed at the safe fill level to float for closure of the pilot valve. The bleed fluid within the pilot line is substantially terminated and subsequently pressurised on closure of the pilot valve and this causes the flow control valve to automatically close at the safe fill level. The patent literature includes many refuelling systems of this design such as the valve assembly disclosed in International patent application No. PCT/AU2003/001436 by Smit, and the refuelling apparatus disclosed in U.S. Pat. No. 8,281,823 by Mitrovich.

In other refuelling systems employing traditional mechanical float valves there is some form of flotation element. These float elements have the role of sensing the raising fluid level into the tank. Once the float element is partially submerged into the fluid, it floats or is raised by the fluid and in doing so triggers some means of valve closure. Such float elements are either hollow components or more recently made of a light density material/foam. Both these designs have drawbacks when used in a high demanding environment such as moving mining equipment/plant, or freight rail applications. High gravitational acceleration, heavy fuel sloshing into the tank, large temperature variation and high filling rates are some factors that potentially cause failure of these components. Most common failures are punctures or loss of airtightness of the hollow designs, and ruptures/fractures of the foam/plastic flotation elements. In an attempt to overcome these problems, the float elements have been protected in enclosures/tubes that have added to the complexity of the valve and delayed the response of the valve to fluid level movement. In order to provide a reliable force to close/open the valve, these floats need to be rather large in volume. The float also needs to respond to a lowering of the fluid in the tank and to trigger some means of opening the valve. In this respect, a ‘light’ floating element with a reduced mass may be insufficient to provide enough force to trigger valve closure.

### SUMMARY OF INVENTION

According to a first aspect of the present invention there is provided a tank level sensor comprising:

a valve body including a pilot inlet adapted to couple to a pilot line for controlling closure of a flow control valve associated with the tank;

a pilot valve mounted to the valve body and in liquid communication with the pilot inlet;

a pilot valve actuator operatively coupled to the pilot valve for its opening and closure, the pilot valve actuator including a balance member arranged to cooperate with actuator biasing means, the balance member having a specific gravity relative to liquid within the tank whereby at least part submersion of the balance member provides movement of the balance member relative to the valve body, said movement of the balance member:
i) only occurring together with the influence of the actuator biasing means; and
ii) being effective in closure of the pilot valve for closure of the flow control valve via the pilot line

According to a second aspect of the invention there is provided a tank overfill protection system comprising:
a) a tank level sensor comprising:
   a valve body including a pilot inlet adapted to couple to a pilot line;
   a pilot valve mounted to the valve body and in liquid communication with the pilot inlet;
   a pilot valve actuator operatively coupled to the pilot valve for its opening and closure, the pilot valve actuator including a balance member arranged to cooperate with actuator biasing means, the balance member having a specific gravity relative to liquid within the tank whereby at least part submersion of the balance member provides movement of the balance member relative to the valve body, said movement of the balance member:
   i) only occurring together with the influence of the actuator biasing means; and
   ii) being effective in closure of the pilot valve;
b) a flow control valve adapted to mount to the tank and operatively coupled to the pilot line whereby closure of the pilot valve of the tank level sensor provides pressurised bleed fluid in the pilot line which is effective in promoting closure of the flow control valve.

Preferably the pilot valve includes a poppet valve having a poppet valve head connected to a valve stem arranged to be contacted by the balance member for opening of the pilot valve. More preferably the valve head is in contact with the actuator biasing means which urges the poppet valve closed. Even more preferably the actuator biasing means includes a pilot compression spring designed to provide sufficient biasing force to provide movement of the balance member relative to the valve body for:
i) closure of the poppet valve on at least part submersion of the balance member with the biasing force of the compression spring overcoming an apparent weight of the balance member;
ii) opening of the poppet valve when the balance member is not at least part submerged and the weight of the balance member overcomes the biasing force of the compression spring.

Preferably the balance member is slidably mounted to an intermediate member which couples the valve body to the tank, the balance member being directly exposed to fluid within the tank to permit at least part submersion of the balance member at or above a safe fill level for closure of the pilot valve. More preferably the balance member includes an elongate recess within which the intermediate member locates for sliding movement of the balance member under the influence of the actuator biasing means to effect closure of the pilot valve. Even more preferably the balance member is shaped cylindrical and the intermediate member is at least in part shaped complementary to the elongate recess of the cylindrical balance member for its sliding movement.

Preferably the valve body is designed to house the pilot valve and includes the pilot inlet in liquid communication with the pilot valve via a pilot passage formed within said valve body. More preferably the valve body includes a pilot opening within which the pilot valve seats for closure, the pilot opening in liquid communication with the pilot passage. Even more preferably the pilot opening provides discharge of bleed fluid from the pilot line into the tank via the pilot passage with the pilot valve opened.

According to a third aspect of the invention there is provided an integrated tank level sensor and venting assembly comprising:
a) a tank level sensor comprising:
   a valve body including a pilot inlet adapted to couple to a pilot line for controlling closure of a flow control valve associated with the tank;
   a pilot valve mounted to the valve body and in liquid communication with the pilot inlet;
   a pilot valve actuator operatively coupled to the pilot valve for its opening and closure, the pilot valve actuator including a balance member arranged to cooperate with actuator biasing means, the balance member having a specific gravity relative to liquid within the tank whereby at least part submersion of the balance member provides movement of the balance member relative to the valve body, said movement of the balance member:
   i) only occurring together with the influence of the actuator biasing means; and
   ii) being effective in closure of the pilot valve for closure of the flow control valve via the pilot line;
b) a tank vent assembly connected to the tank level sensor, said vent assembly comprising:
   a tank vent body adapted to mount to the tank, said vent body including one or more vent passages arranged to permit breathing of gas between the tank and atmosphere;
   a tank vent valve coupled to the tank vent body and arranged relative to the vent passages to effect their closure in the event the liquid within the tank exceeds a safe fill level, the tank vent valve thus preventing the discharge of the liquid from the tank via the vent passages.

Preferably the tank vent assembly is configured wherein closure of the vent passages via the tank vent valve causes pressurisation of the tank and subsequently automatic closure of a refilling nozzle associated with the tank. More preferably said closure of the refilling nozzle prevents the tank filling substantially beyond the safe fill level.

Preferably the tank vent valve includes a float vent valve designed to float under the influence of liquid within the tank exceeding the safe fill level, said flotation of the float vent valve effecting closure of the vent passages. More preferably the float vent valve includes a float configured to be slidably displaced along an intermediate member connected between the tank level sensor and the tank vent body, the float being raised upward of the intermediate member for closure of the vent passages in the event the liquid level within the tank exceeds the safe fill level.

Preferably the integrated tank level sensor and venting assembly also comprises a pressure relief valve sub-assembly operatively coupled to the tank vent assembly and arranged to relieve pressure from the tank. More preferably said pressure relief sub-assembly includes a pressure relief piston arranged under excess pressure to be displaced relative to the tank vent body to expose a pressure relief passageway formed in the tank vent body and arranged to permit pressure relief from within the tank via said relief passageway. Even more preferably the pressure relief piston is ring-shaped and designed to move within a vent chamber formed within the tank vent body and arranged for fluid communication with the pressure relief passageway, the ring-shaped piston including a central piston opening which provides breathing between the vent passages and the vent chamber. Still more preferably the pressure relief valve includes pressure relief biasing means arranged to urge the pressure relief piston closed except when excess pressure in the tank overcomes biasing force of the pressure relief biasing means to displace the pressure relief piston for exposure of the pressure relief passageway for pressure relief via the vent chamber. Even still more preferably the pressure relief passageway is separate from the vent passages whereby the pressure relief functions at least partly independent of tank breathing. Yet still more preferably the pressure relief valve sub-assembly also includes a tank pressure witness gauge operatively coupled to the tank vent body and in fluid communication with the pressure relief passageway.

Preferably the integrated tank level sensor and venting assembly further comprises a rollover valve sub-assembly operatively coupled to the pressure relief valve sub-assembly and arranged to prevent discharge of liquid from the tank in the event it is inclined beyond a predetermined rollover angle. More preferably the rollover valve sub-assembly includes a valve head arranged to cooperate with an internal mount located within the vent chamber, said tank vent body having a discharge opening at or adjacent the vent chamber and arranged to cooperate with the valve head whereby at tank incline angles:
i) greater than the predetermined rollover angle, the valve head moves to close the discharge opening to prevent the discharge of fluid from the tank via the discharge opening;
ii) less than the predetermined rollover angle, the valve head maintains the discharge opening open promoting breathing of gas between the tank and the vent chamber.
   Even more preferably the rollover valve sub-assembly includes rollover biasing means operatively coupled to the valve head to move it for closure of the discharge opening at tank incline angles greater than the predetermined rollover angle, the rollover biasing means having a biasing force which is overcome by the weight of the valve head at tank incline angles less than the predetermined rollover angle to maintain opening of the discharge opening. Even still more preferably the rollover biasing means includes a rollover compression spring.

According to a fourth aspect of the invention there is provided a refilling system for multiple tanks, said system comprising:
a) a tank vent assembly associated with an upstream tank, said vent sub-assembly including:
   a tank vent body adapted to mount to the tank, said vent body including one or more vent passages arranged to permit breathing of gas between the upstream tank and atmosphere;
   a tank vent valve coupled to the tank vent body and arranged relative to the vent passages to effect their closure in the event the liquid within the upstream tank exceeds a safe fill level, the tank vent valve thus preventing the discharge of the liquid from the upstream tank via the vent passages;
b) a pressure relief valve sub-assembly integrated with the tank vent assembly, said pressure relief valve sub-assembly including a pressure relief piston arranged under excess pressure to be displaced relative to the tank vent body to expose a pressure relief passageway formed in the tank vent body and arranged to permit pressure relief from within the upstream tank via said pressure relief passageway;
c) a flow control valve adapted to mount to the upstream tank for filling of said upstream tank, said flow control valve operatively coupled to the tank vent body via a pilot line arranged downstream of the tank vent body to be in bleed fluid communication with a tank level sensor mounted to an associated downstream tank being filled from the upstream tank, said level sensor arranged to detect a safe fill level in the downstream tank and trigger the flow control valve for closure via pressurised bleed fluid in the pilot line.

Preferably the pilot line connects internally of the upstream tank between the flow control valve and the tank vent body of the upstream tank. More preferably the pilot line connects externally of the upstream tank and the downstream tank between the tank vent body of the upstream tank and the tank level sensor of the downstream tank.

Preferably the tank level sensor of the downstream tank comprises:

a valve body including a pilot inlet adapted to couple to the pilot line for controlling closure of the flow control valve at the upstream tank;

a pilot valve mounted to the valve body and in liquid communication with the pilot inlet;

a pilot valve actuator operatively coupled to the pilot valve for its opening and closure, the pilot valve actuator including a balance member arranged to cooperate with actuator biasing means, the balance member having a specific gravity relative to liquid within the downstream tank whereby at least part submersion of the balance member provides movement of the balance member relative to the valve body, said movement of the balance member:
i) only occurring together with the influence of the actuator biasing means; and
ii) being effective in closure of the pilot valve for closure of the flow control valve via the pilot line.

### BRIEF DESCRIPTION OF DRAWINGS

In order to achieve a better understanding of the nature of the present invention a preferred embodiment of a tank level sensor and a tank overfill protection system will now be described, by way of example only, with reference to the accompanying drawings in which:

FIG. 1 is a schematic illustration of a first embodiment of a tank overfill protection system according to the present invention;

FIGS. 2A and 2B are details B and C showing a tank level sensor and flow control valve, respectively, taken from the first embodiment of the tank overfill protection system of FIG. 1;

FIGS. 3A to 3E shows various sectional views of the tank level sensor of the first embodiment with the associated pilot valve open or closed;

FIGS. 4A to 4F shows various sectional, exploded and pictorial views of the flow control valve of the first embodiment in its open or closed positions;

FIGS. 5A to 5E shows various sectional views of the tank level sensor of the first embodiment in its various operating modes;

FIG. 6 is a schematic illustration of a second embodiment of a tank overfill protection system according to the invention;

FIGS. 7A and 7B are details D and E showing the tank level sensor and flow control valve, respectively, taken from the second embodiment of FIG. 6;

FIG. 8 is a schematic illustration of one embodiment of a refilling system for multiple tanks according to another aspect of the invention;

FIG. 9 is a sectional view of the tank vent assembly taken from the refilling system of FIG. 8.

### DETAILED DESCRIPTION

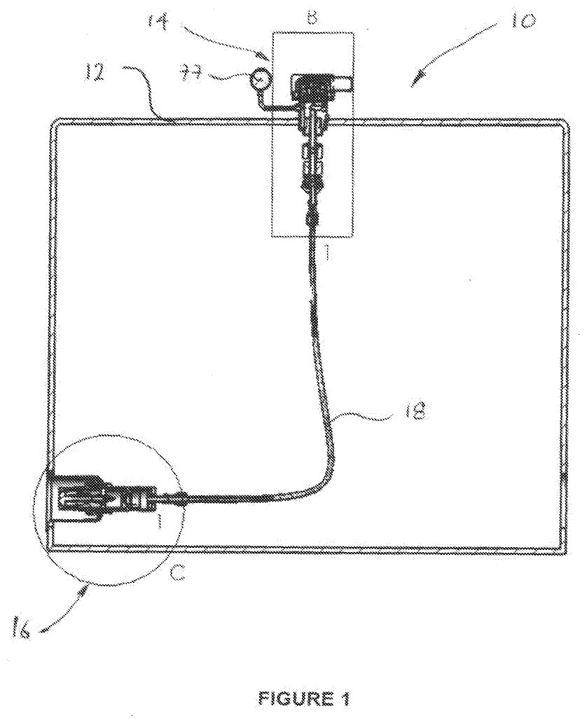

As shown in FIG. 1 there is an embodiment of a tank overfill protection system 10 according to one aspect of the invention and designed to be installed in a tank 12, preferably a fuel tank. The tank overfill protection system 10 generally comprises a tank level sensor 14 operatively coupled to a flow control valve assembly 16. In a conventional manner the flow control valve assembly 16 is connected to the level sensor 14 via a pilot line 18 which contains a bleed fluid (not designated) for controlling closure of the flow control valve assembly 16. In this embodiment the pilot line 18 is located internally of the fuel tank 12.

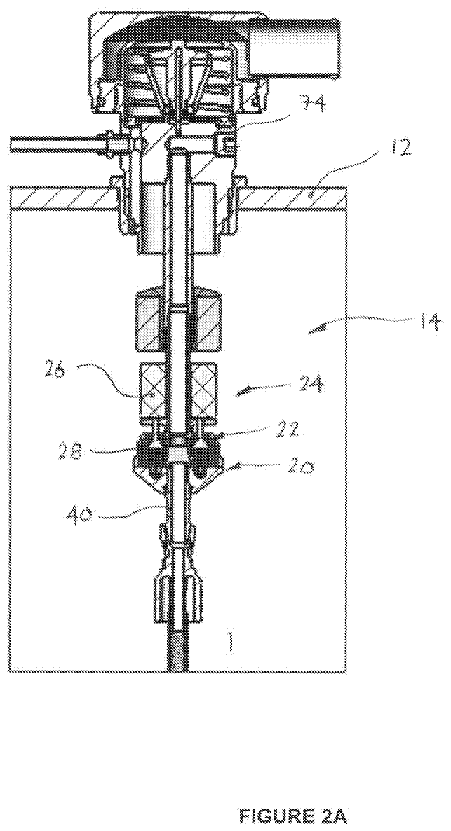

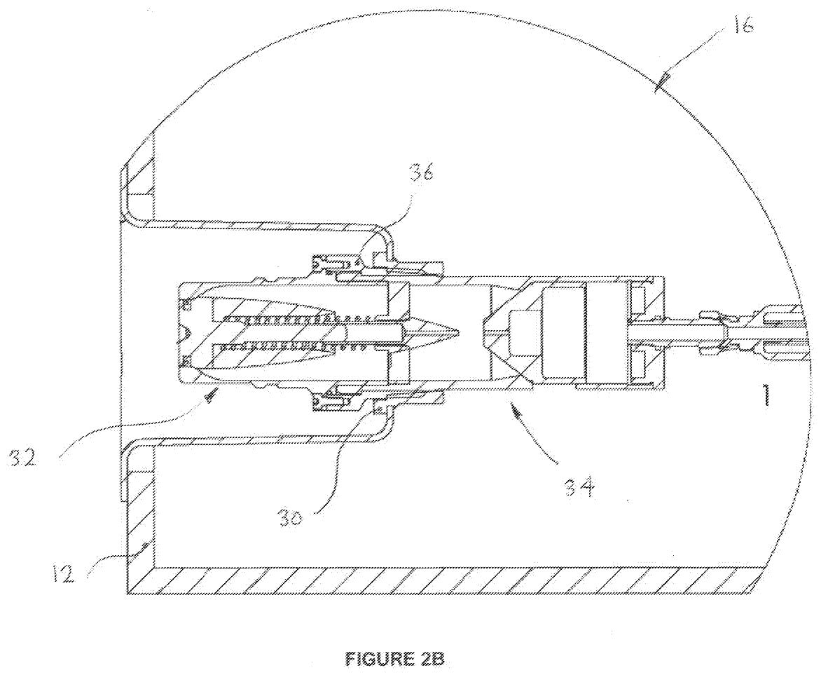

As shown in the detailed view of FIG. 2A the tank level sensor 14 generally comprises a valve body 20, a pilot valve 22 mounted to the valve body 20, and a pilot valve actuator 24 operatively coupled to the pilot valve 22 for its opening and closure. The pilot valve actuator 24 includes a balance member 26 arranged to cooperate with actuator biasing means 28 in the form of a pilot compression spring. The balance member 26 is in the form of a counterbalance and has a specific gravity relative to liquid or fuel within the tank 12 so that at least part submersion of the balance member 26 under the influence of the pilot compression spring 28 provides movement of the balance member 26 and closure of the pilot valve 22. Generally, this means the balance member 26 is of an overall density greater than the liquid or fuel and thus will not float when immersed in the liquid or fuel. This closure of the pilot valve 22 substantially closes and subsequently pressurises the bleed fluid in the pilot line 18 for closure of the flow control valve assembly 16. Importantly, the counterbalance member 26 without the biasing influence of the pilot compression spring 28 (or in the absence of the spring 28) will not move on submersion of the said member 26 and the pilot valve 22 will remain open.

As seen in the detailed view of FIG. 2B the flow control valve 16 is threadingly, flanged, or otherwise connected to the fuel tank 12, in this example via a threaded shell 30 fitted to the tank 12. The flow control valve assembly 16 comprises a front end receiver sub-assembly 32 coupled to a backend flow control valve sub-assembly 34. In this embodiment the receiver sub-assembly 32 has a flanged connection with an intermediate connector 36 which is directly screwed inside the threaded shell 30. The flow control valve sub-assembly 34 connects to the pilot line 18 for the provision of bleed fluid to the tank level sensor 14. The receiver sub-assembly 32 is configured in a conventional manner to provide latching for a refuelling nozzle (not shown) for refuelling of the fuel tank 12.

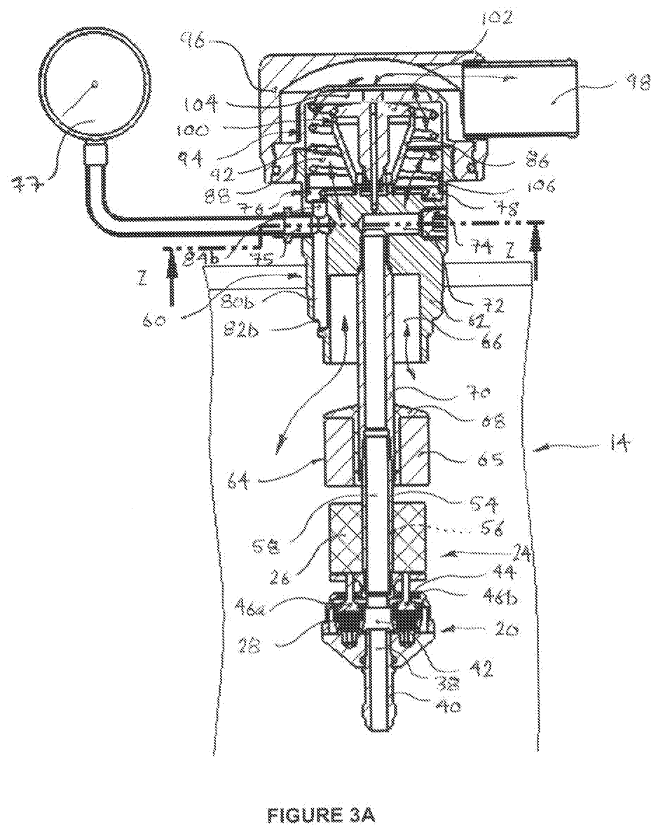

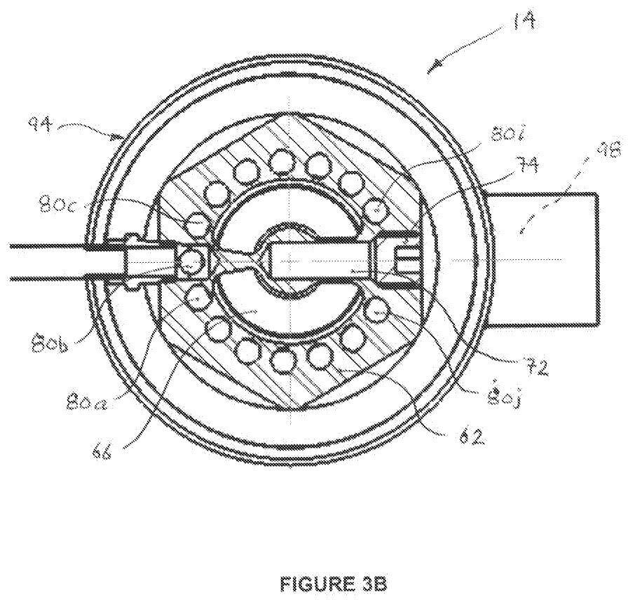

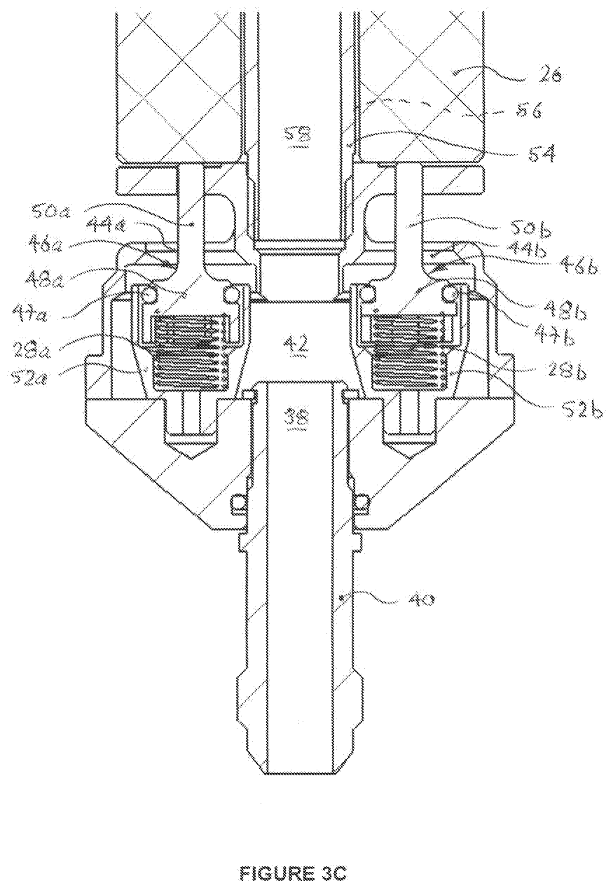

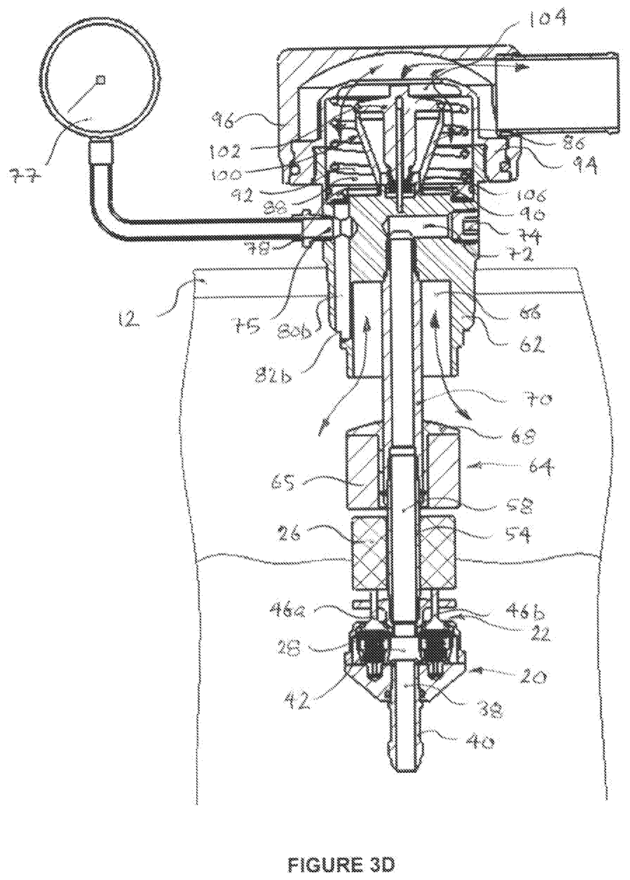

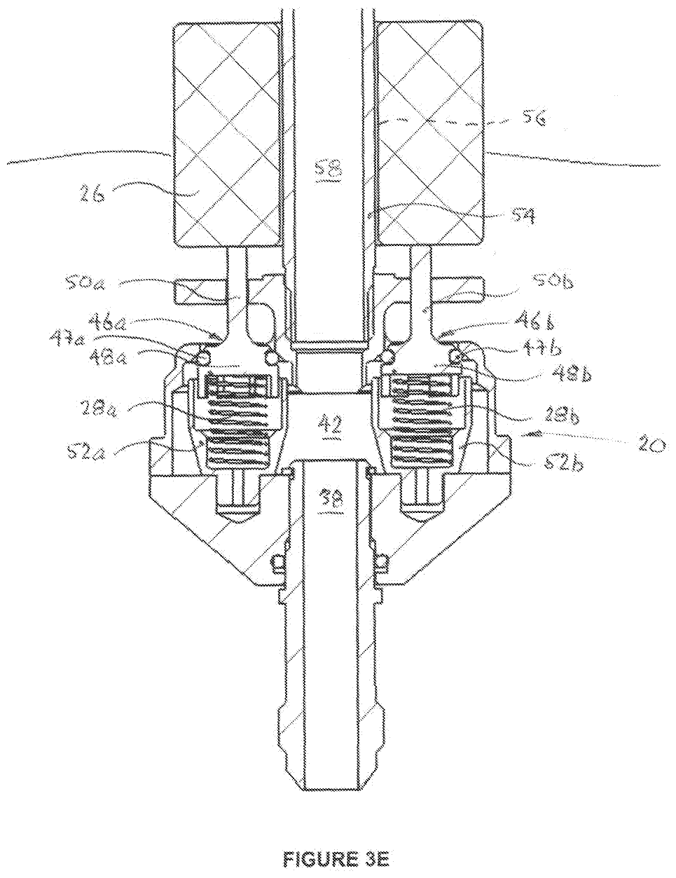

FIGS. 3A to 3E illustrates the tank level sensor 14 according to one aspect of the invention taken from the tank overfill protection system 10 of FIG. 1. The valve body 20 includes a pilot inlet 38 connected to the pilot line 18 via a swivelling tail coupling 40. The pilot inlet 38 is in liquid or bleed fluid communication with the pilot valve 22 via a pilot passage 42 formed within the valve body 20. The valve body 20 also includes a pilot opening 44 within which the pilot valve 22 seats for closure. The pilot passage 42 is in bleed fluid communication with the pilot opening 44 for the discharge of bleed fluid into the tank 12 with the pilot valve 22 open.

In this embodiment the pilot valve 22 is one of a pair of poppet, needle, or jumper valves 46a and 46b having a valve head such as 48a together with a valve seal 47a arranged to be seated in the respective pilot opening 44a for closure of the jumper valve such as 22a. The valve head 48a is integrally connected to a valve stem such as 50 which extends outside the valve body 20 for contact with the balance member 26 for opening of the jumper valve 22. The counterbalance member 26 contacts the valve stem 50 without being connected to the stem 50. In this example the pilot compression spring such as 28a housed within the valve body 20 contacts the corresponding valve head 48a urging the jumper valve 22a closed. Importantly the pilot compression spring such as 28a is designed to provide sufficient biasing force to provide movement of the balance member 26 relative to the valve body 20 for both:
1. closure of the jumper valves 22a/b on at least part submersion of the balance member 26 with the biasing force of the compression springs 28a/b overcoming an apparent weight of the balance member 26 which would otherwise not move upward;
2. opening of the jumper valves 22a/b when the balance member 26 is not submerged and the weight of the balance member 26 overcomes the biasing force of the compression springs 28a/b.

In this embodiment the pilot compression springs 28a/b are located within respective cup-shaped mountings 52a/b secured within the pilot passage 42 which extends radially outwardly of the valve body 20. The springs 28a/b are of a predetermined design stiffness relative to the apparent weight of the counterbalance member 26 to achieve the required functionality in opening and closing of the jumper valves 22a/b

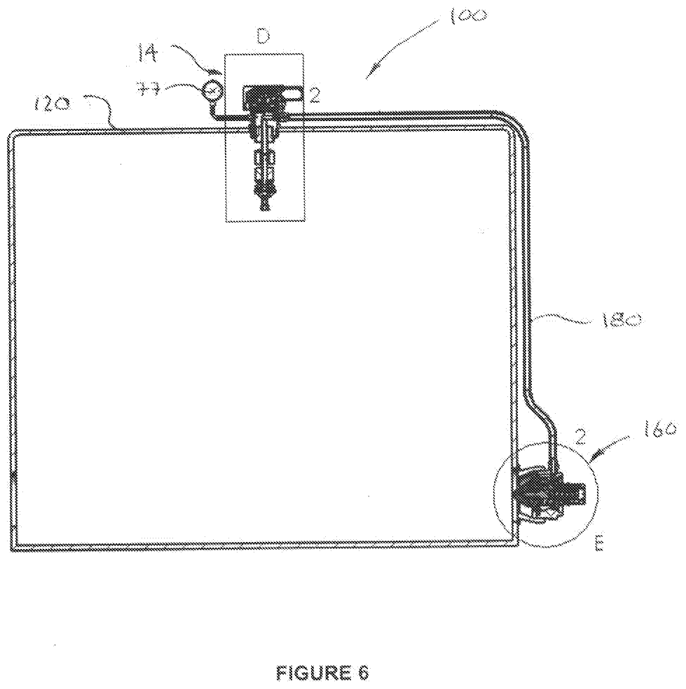

In this embodiment the balance member 26 is slidably mounted to an intermediate member 54 which assists in coupling of the valve body 20 to the tank 12. The balance member 26 is shaped cylindrical and includes an axially-oriented elongate recess 56 within which the intermediate member 54 locates for sliding movement of the balance member 26. The intermediate member 54 is in this example in the form of a hollow tube having an elongate passageway 58 in fluid communication with the pilot passage 42 for the option of connecting the pilot line externally of the tank 12 between the tank level sensor 14 and the flow control valve, see FIG. 6.

The tank level sensor 14 is according to another aspect of the invention connected integral with a tank vent assembly designated generally as 60. The tank vent assembly 60 comprises a tank vent body 62 mounted to the tank 12, and a tank vent valve 64 operatively coupled to the tank vent body 62. The tank vent body 62 includes an internal vent passage 66 arranged to permit tank breathing and in particular venting of gas, and in particular air and/or fuel vapour, from within the tank 12 to atmosphere. Tank breathing allows the ingress of air to the tank 12 via the tank vent assembly 60 during emptying of liquid or fuel from the tank 12. The tank vent valve 64 is in this example a float vent valve designed to float under the influence of liquid within the tank 12 exceeding a safe fill level. This flotation of the float vent valve 64 provides closure of the internal vent passage 66 to prevent the discharge of liquid, fuel or gas from the tank 12 via the vent passage 66.

In this embodiment the float vent valve 64 includes a generally cylindrical-shaped float 65 including a sleeve 68 having a dome-shaped head 69 designed to seat with the entry of the internal vent passage 66. The float 65 is slidably displaced along a hollow stem 70 connected at opposing ends to the hollow tube of the intermediate member 54 and the tank vent body 62, respectively. The hollow stem 70 is axially aligned with the intermediate member 54 and in bleed fluid communication with the bleed passageway 58 for connection to the external pilot line of FIG. 6. The tank vent body 62 includes a radial opening 72 which is redundant with the internally connected pilot line 18 of this embodiment and thus is plugged with isolation plug 74.

In this embodiment the integrated tank level sensor and venting assembly 14 also comprises a pressure relief valve sub-assembly 76 operatively coupled to the tank vent assembly 60 and arranged to relieve pressure from the tank 12. The pressure relief sub-assembly 76 includes a pressure relief piston 78 arranged under excess pressure to be displaced relative to the tank vent body 62 to expose a pressure relief passageway 80 formed in the tank vent body 62. In this example the pressure relief passageway 80 is one of a plurality of pressure relief passageways such as 80a oriented axially and spaced circumferentially around the tank vent body 62. The pressure relief passageways such as 80a each include an entry port 82a exposed to gas, and in particular air and/or fuel vapour, within the tank 12, and an exit port 84a arranged to be sealed by the pressure relief piston 78. Importantly the pressure relief passageways such as 80a are separate from and arranged concentric with the internal vent passage 66 whereby pressure relief functions at least partly independent of regular tank breathing.

The tank vent body 62 includes a witness gauge port 75 for attachment of a tank pressure witness gauge 77. The witness port 75 is in fluid communication with one of the pressure relief passageways such as 80b and thus the witness gauge 77 provides an indication of pressure within the tank 12. For example, if the level sensor 14 fails to close the flow control valve assembly 16, the tank will be subject to internal pressurisation and the pressure witness gauge 77 will indicate an occurrence of “excessive” tank pressurisation. The witness gauge 77 may in a preferred embodiment be in the form of a mechanical (e.g. bourdon style) pressure gauge with a (manually resettable) drag pointer or:
a. An electronic pressure gauge, for example an LCD gauge;
b. A pressure transmitter, sending a signal corresponding to the internal tank pressure to a remote data acquisition/display device.

The witness gauge 77 thus provides an operator with a visual alert and diagnostic indicator in the event of a system failure and over pressurisation. The degree of pressurisation is an indication of a level sensor failure, or a combination of a level sensor and pressure-sensitive nozzle malfunction. Without a reliable means of fault indication and alert (such as the witness gauge 77), the tank may be repeatedly subject to pressurisation resulting in its rupture. The witness gauge 77 of this embodiment provides the operator with means for detecting a faulty tank level sensor. If the witness gauge 77 is not installed then the witness port 75 is plugged in a similar manner to plugging of the redundant port not used by the pilot line.

In this embodiment the pressure relief piston 78 is ring-shaped having a central piston opening 90 which provides breathing between the internal vent passage 66 of the tank vent body 62 and a vent chamber 88. The ring-shaped pressure relief piston 78 is ordinarily urged into sealing closure with the exit port such as 84a of the pressure relief passageway such as 80a. For this purpose the pressure relief valve 76 includes pressure relief biasing means 92 in the form of a compression spring housed at least partly within the vent chamber 88. When excess pressure in the tank 12 overcomes the biasing force of the pressure relief compression spring 92, the pressure relief piston 78 is displaced to expose the pressure relief ports such as 80a for pressure relief from the tank 12 via the vent chamber 88. The setting of the pressure relief valve 76 can be configured to suit a prescribed tank relief pressure. The vent chamber 88 ordinarily breathes with the internal vent passage 66 via the central piston opening 90 independent of the pressure relief passageways such as 80b.

In this embodiment the tank vent assembly 60 also comprises an internal mount 86 located within the vent chamber 88. This vent chamber 88 is in fluid communication with the internal vent passage 66 for direct breathing of gas between the tank 12 and atmosphere. This breathing occurs through the vent chamber 88 outside of the internal mount 86.

In this embodiment the integrated tank level sensor and venting assembly 14 includes a cap 94 and chimney 96 for discharge to atmosphere. The cap 94 is affixed to the tank vent body 62 and the chimney 96 is in turn secured to the cap 94. The chimney 96 includes a spout 98 for breathing of gas such as air and/or fuel vapour to and from the atmosphere. In this example the tank vent body 62 is mounted to the ceiling of the tank 12 for mounting of the integrated tank level sensor and venting assembly 14 to the tank 12.

In this embodiment the integrated tank level sensor and venting assembly 14 further comprises a rollover valve sub-assembly 100 arranged to prevent discharge of liquid, fuel or gas from the tank 12 in the event it is inclined beyond a predetermined rollover angle. The rollover valve sub-assembly 100 includes a valve head 102 arranged to cooperate with the internal mount 86. The cap 94 connected to the tank vent body 62 includes a discharge opening 104 tapered inwardly and arranged to provide seating closure for a head seal 108 associated with the valve head 102. The rollover valve sub-assembly 100 includes rollover biasing means 106 in the form of a compression spring operatively coupled to the valve head 102 for closure of the discharge opening 104 at tank incline angles greater than the predetermined rollover angle. In operation the rollover valve sub-assembly 100 functions whereby the valve head 102 at tank incline angles:
1. greater than the predetermined rollover angle is moved under the influence of the rollover compression spring 106 to close the discharge opening 104 to prevent the discharge of air, vapour or other fluid from the tank 12;
2. less that the predetermined rollover angle is maintained for opening of the discharge opening 104 promoting breathing of gas between the tank and atmosphere via the vent chamber 88.

The rollover compression spring 106 is designed with a biasing force which is overcome by the weight of the valve head 102 at tank incline angles less than the predetermined rollover angle. The predetermined rollover angle depends on the application and may be pre-set accordingly. In this embodiment the roller valve sub-assembly 100 acts independent of the tank vent assembly 60 and the pressure relief valve sub-assembly 76.

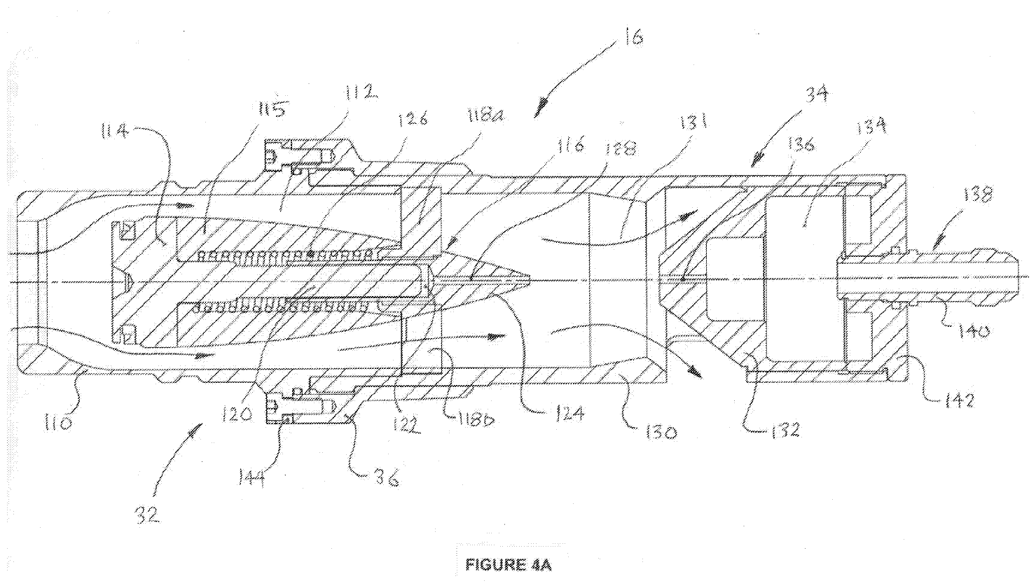

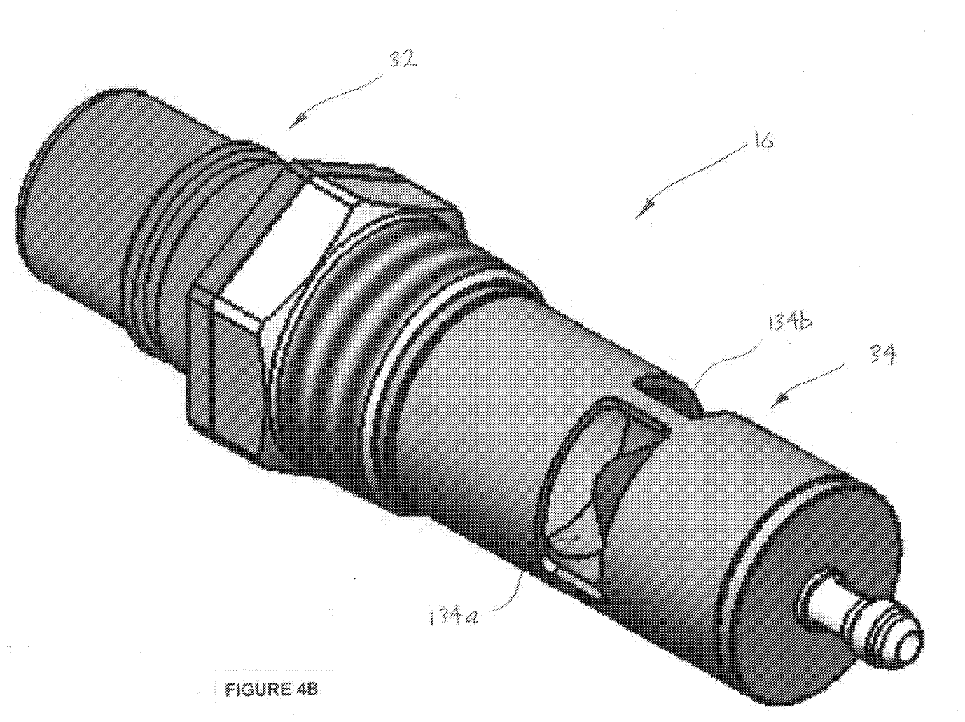

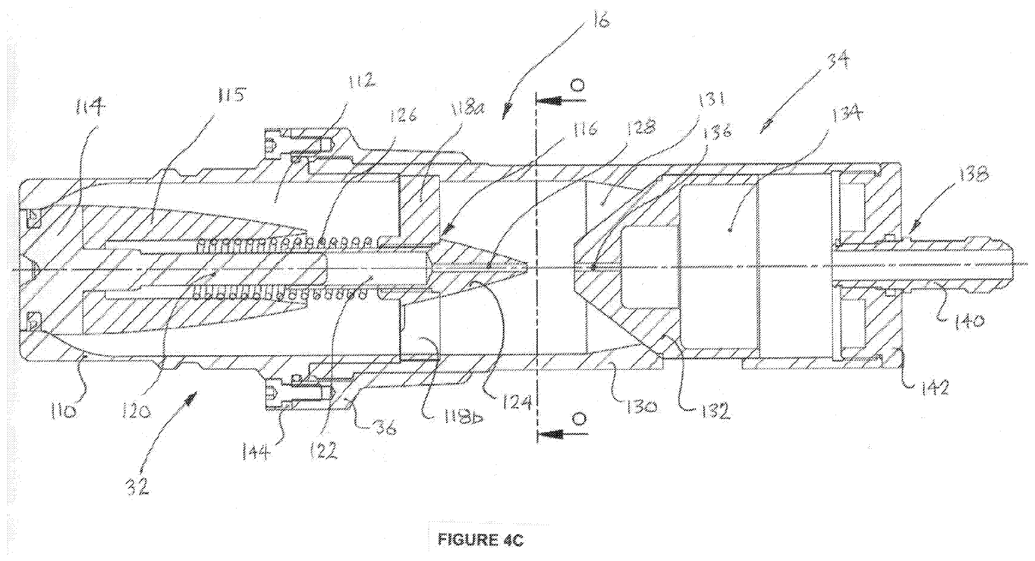

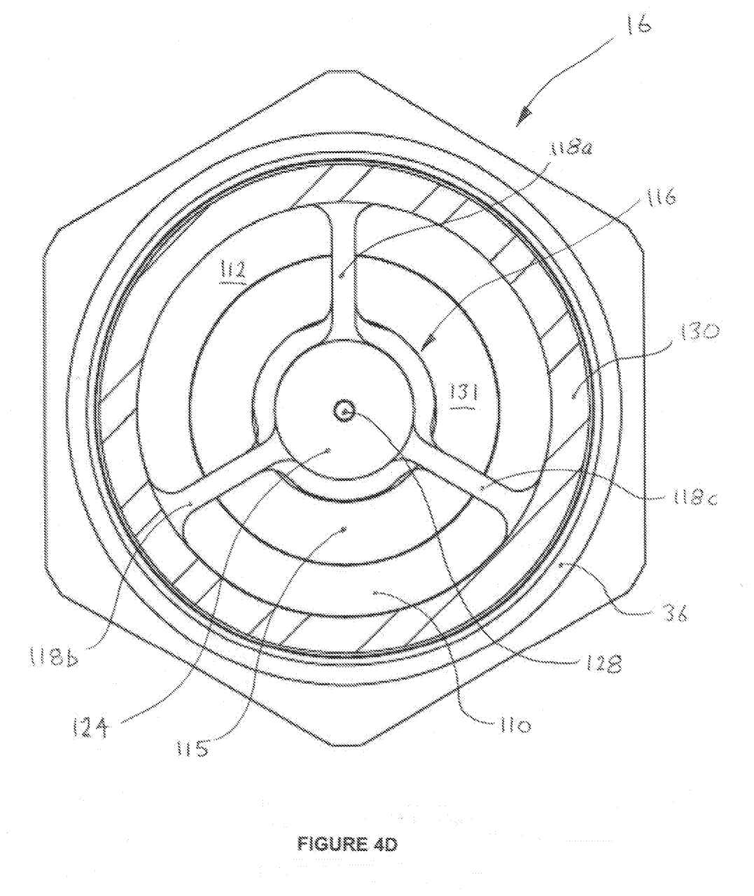

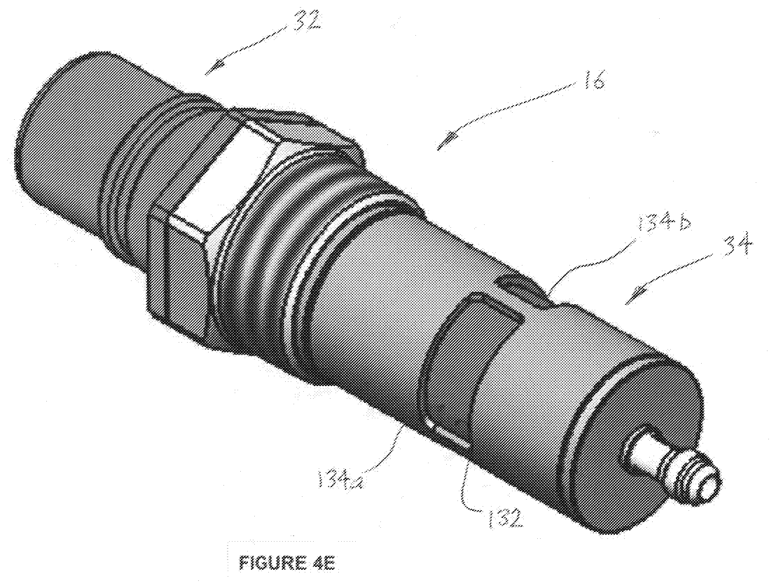

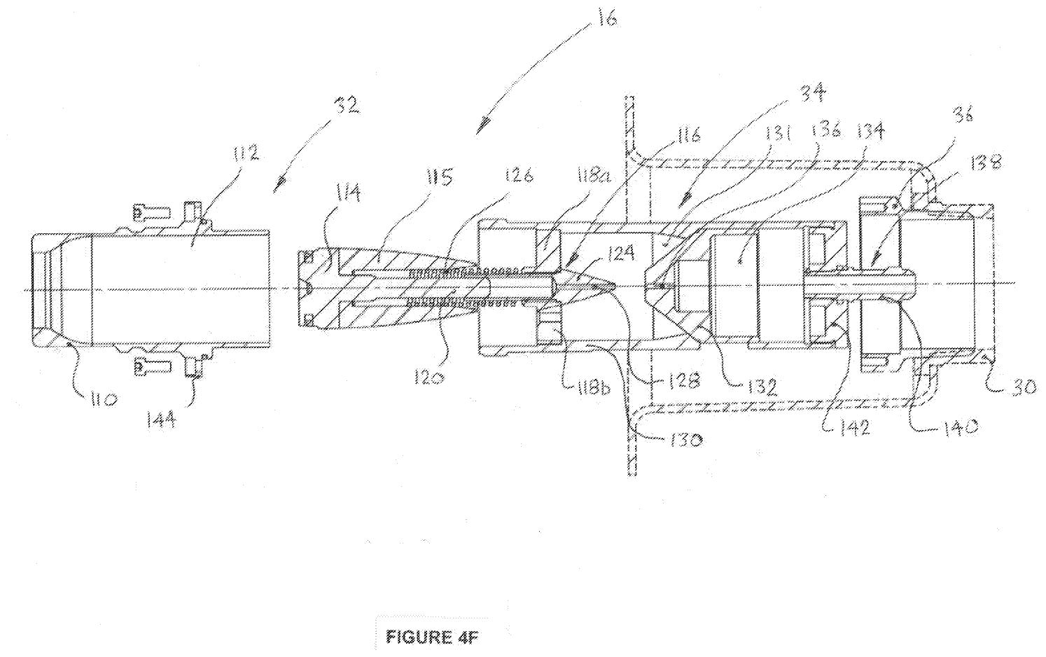

As best seen in FIGS. 4C to 4E the flow control valve assembly 16 is closed in preparation for refuelling of the tank 12. On connection of the refuelling nozzle (not shown) the flow control valve assembly 16 is opened as shown in FIGS. 4A and 4B. In a conventional manner the refuelling nozzle contacts the receiver sub-assembly 32 to open the flow control valve assembly 16 whereby the flow of liquid or fuel promotes opening of the flow control valve sub-assembly 34. When fuel within the tank 12 reaches a safe fill level, the pilot valve 22 of the tank level sensor 14 is substantially closed pressurising bleed fluid within the pilot line 18. The pressurised bleed fluid in the pilot line 18 promotes closure of the flow control valve sub-assembly 34 to prevent further flow of fuel to the tank 12.

The front end receiver sub-assembly 32 of this embodiment includes a receiver body 110 which defines a fluid receiver passageway 112 in which a receiver poppet 114 and conical-shaped diffuser 115 are received. The receiver poppet 114 is slidably mounted to an axial mount 116 secured within the flow control valve assembly 16 via radial legs such as 118a and 118b. In this example the receiver poppet 114 includes a rod 120 which axially reciprocates within an axial bore 122 of a post 124 associated with the axial mount 116. The receiver poppet 114 and diffuser 115 are urged closed via poppet biasing means 126 in the form of a compression spring housed between the diffuser 115 and the post 124 of the axial mount 116. The receiver poppet 114, the diffuser 115, the axial mount 116 and the post 124 at its downstream end are shaped in such a way as to create a minimum resistance to flow as depicted in FIG. 4A. The post 124 at its downstream end includes bleed passage 128 designed to relieve any hydraulic pressure within the axial bore 122 which may otherwise restrict opening of the receiver poppet 114 and diffuser 115.

In this embodiment the flow control valve sub-assembly 34 includes a flow control valve body 130 defining a flow control valve passageway 131 within which a flow control valve piston 132 is slidably housed for opening and closing side wall openings such as 134a and 134b of the flow control valve body 130. The flow control valve piston 132 includes a bleed fluid cavity 134 in bleed fluid communication with the pilot line 18. The bleed fluid cavity 134 is designed to promote closure of the flow control valve piston 132 relative to the side wall openings 134a/b when the jumper valves 22 of the tank level sensor 14 close. This sliding movement and closure of the flow control valve piston 132 is effected by the differential pressure created by the pressurised bleed fluid within the bleed fluid cavity 134 relative to the pressure of the fluid within the flow control valve passageway 131. This hydraulic actuation of the flow control valve piston 132 distinguishes from conventional flow control valves associated with refuelling applications which rely on a valve spring to ordinarily bias the flow control valve closed. The flow control valve piston 132 of this example is also provided with an axial bleed passage 136 designed to allow fluid or fuel to bleed from the flow control valve passageway 131 into the bleed fluid cavity 134 and into the pilot line 18.

In this embodiment the flow control valve sub-assembly 34 includes a tail connector 138 for connection to the pilot line 18. The tail connector 138 includes a swivel fitting 140 mounted within an end cap 142 fixed to the flow control valve body 130. The swivel fitting 140 is designed to swivel axially within the end cap 142 and thus accommodates relative rotation between the pilot line 18 and the flow control valve assembly 16 without twisting of the pilot line 18 which may otherwise adversely affect the flow of fluid through the pilot line between the flow control valve assembly 16 and the tank level sensor 14.

As best seen in FIG. 4F mounting of the flow control valve assembly 16 to the fuel tank 12 is effected according to the following sequence of events:
1. the intermediate connector 36 is secured to the threaded shell 30 provided at the base of the tank 12, or may otherwise be connected to the tank 12;
2. the pilot line 18 is retracted from within the tank 12 and connected to the swivel fitting 140;
3. the flow control valve sub-assembly 34 is retained within the intermediate connector 36;
4. the receiver sub-assembly 32 housing the receiver poppet 114 and diffuser 115 is fastened to the intermediate connector 36 using its flanged connection 144.

It should be noted that this mounting sequence and in particular the flanged connection of the receiver sub-assembly 32 to the intermediate connector 36 avoids rotation of the flow control valve assembly 16. This rotation of the flow control valve in the course of assembly or replacement of the receiver sub-assembly is practiced in conventional systems and results in twisting and kinking of the associated internal pilot line possibly causing malfunction of the system.

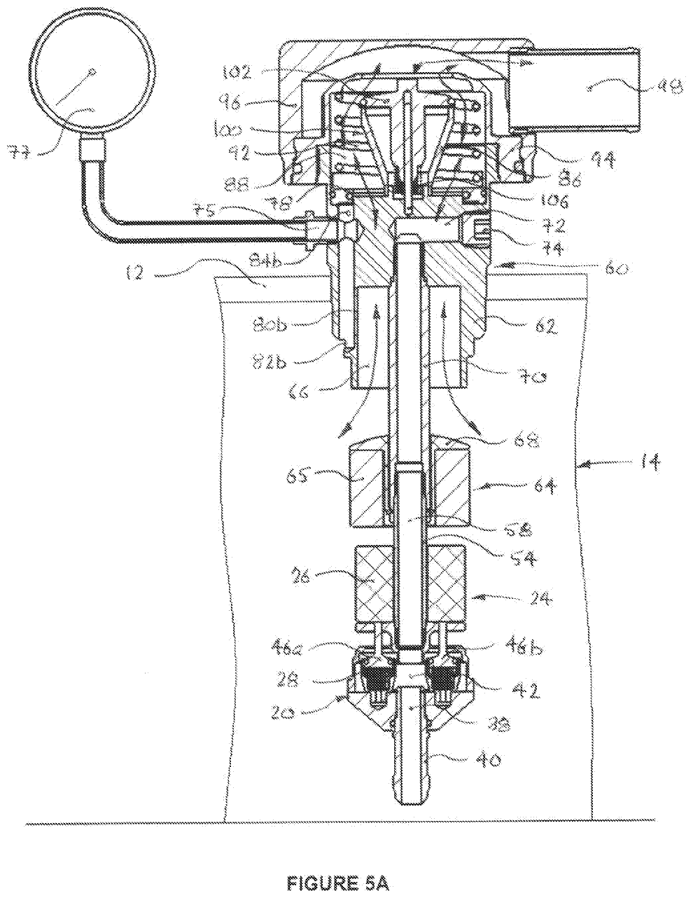

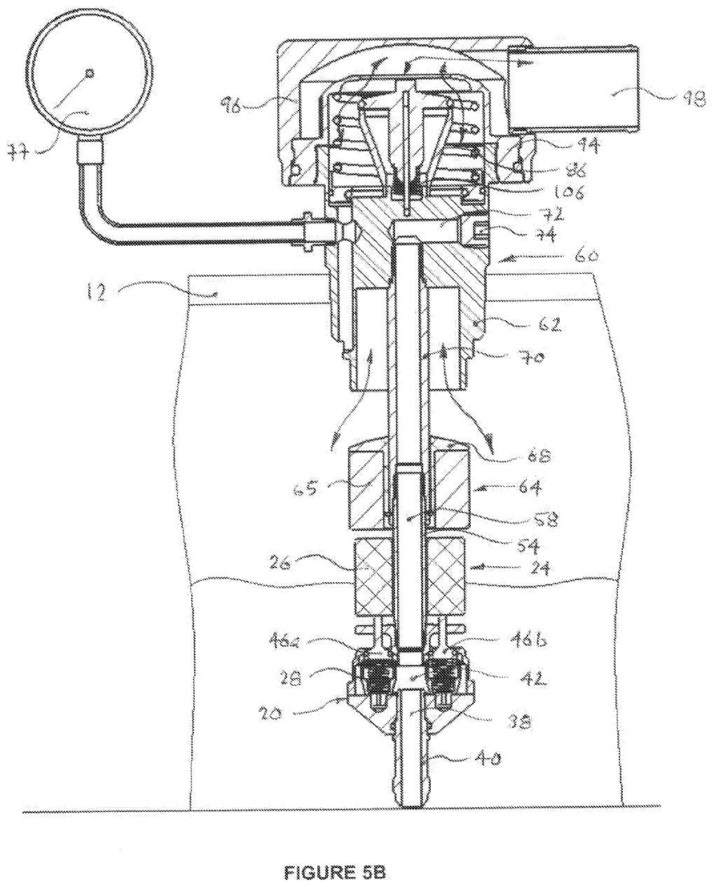

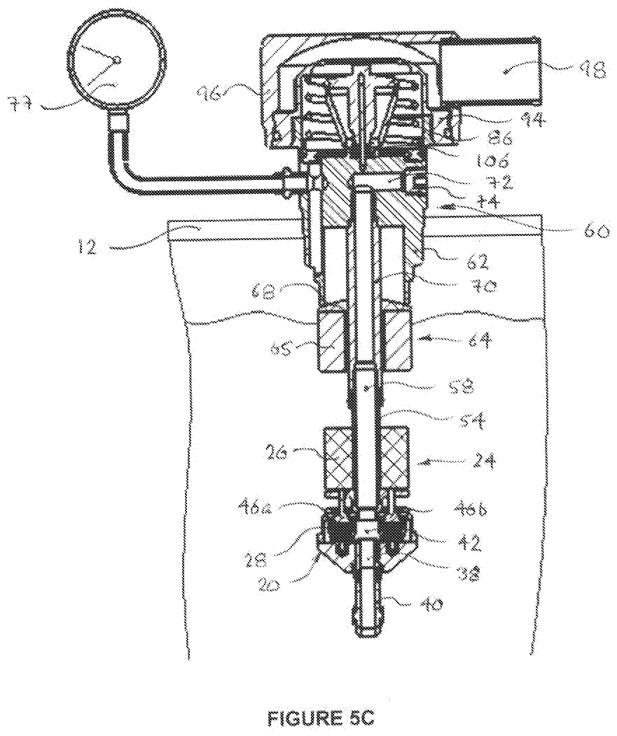

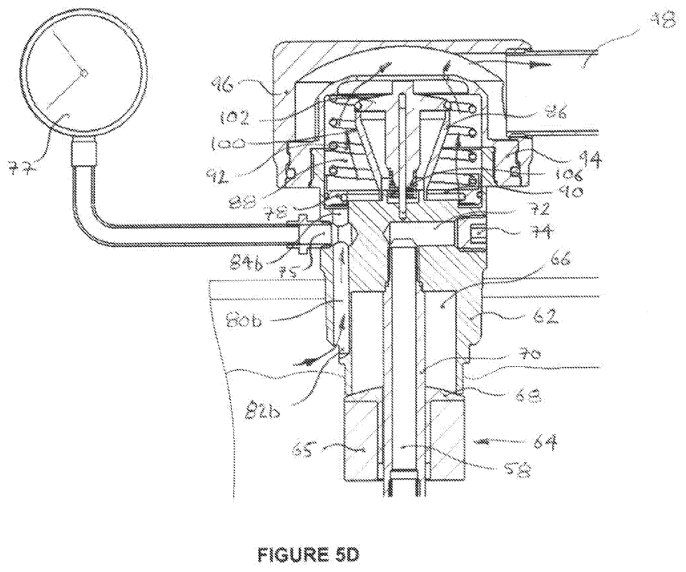

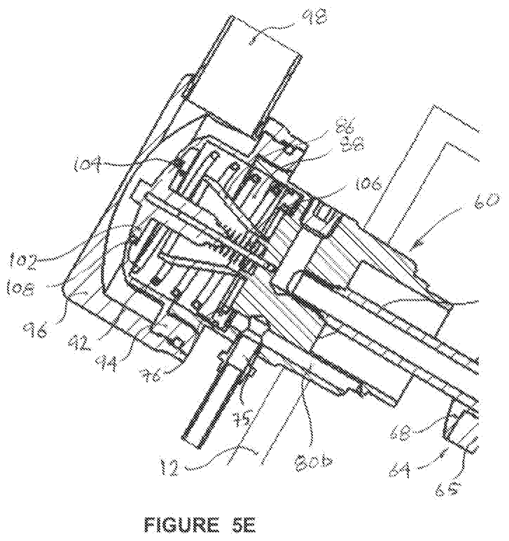

FIGS. 5a to 5e illustrate operation of the tank level sensor 14 in its various operational modes. In moving through these representations it can be seen that in FIG. 5:
(a) the jumper valves 22 are open during refuelling of the tank 12 via a refuelling nozzle (not shown) with the balance member 26 contacting the jumper valves 22 and moving them downward against the biasing force of the actuating biasing means 28 whereby bleed fluid is bled into the tank 12 and wherein gas is free to vent from the tank vapour space to atmosphere via the internal vent passage 66;
(b) the tank reaches a safe fill level, or nominated (prescribed) safe fill level, where the balance member 26 is at least part submerged and under the influence of the actuator biasing means 28 is moved upward effecting closure of the jumper valves 22 for pressurisation of the bleed fluid within the pilot line 18 for closure of the flow control valve assembly 16 whilst gas continues to vent to atmosphere (the counterbalance member 26 will not otherwise move upward without the biasing force of the biasing means 28);
(c) in the event the flow control valve assembly 16 malfunctions and fuel or other tank contents rises above the safe fill level, the float valve 64 effects closure of the vent passage 66 to in one embodiment pressurise the tank 12 and cause an associated refilling nozzle (not shown) to shut-off and prevent overfilling and spillage;
(d) in the event that fuel enters the tank 12 beyond the safe fill level causing overpressure of the tank 12, the pressure relief valve sub-assembly 76 is activated permitting discharge of gas and/or liquid via the pressure passageways 80;
(e) in the event the tank experiences a rollover, the rollover valve sub-assembly 100 effects closure of the valve head 102 with the discharge opening 104 to prevent discharge of gas or liquid from the tank 12.

The refuelling nozzle is typically a pressure-sensitive nozzle designed to automatically shut off at a preset pressure. This automatic shutoff is a backup to the hydraulically controlled flow control valve assembly 16 in the event it fails. If the refuelling nozzle does not include a pressure sensitive mechanism for shutoff, the system relies solely on the flow control valve assembly 16 such as that disclosed in the preferred embodiment for overfill protection.

The integrated tank level sensor and venting assembly 14 of this embodiment is effective in providing an air cushion (ullage) or vapour space between the tank liquid level and the lid or ceiling of the tank. This air cushion (ullage) is provided at or above the safe fill level for the tank on closure of the tank vent valve 64 and whilst the pressure relief valve sub-assembly 76 remains closed. The air cushion is effective in triggering the pressure-sensitive mechanism of the pressure-sensitive refuelling nozzle (not shown) and preventing possible spillages due to fuel movement (sloshing) within the tank 12 or thermal expansion.

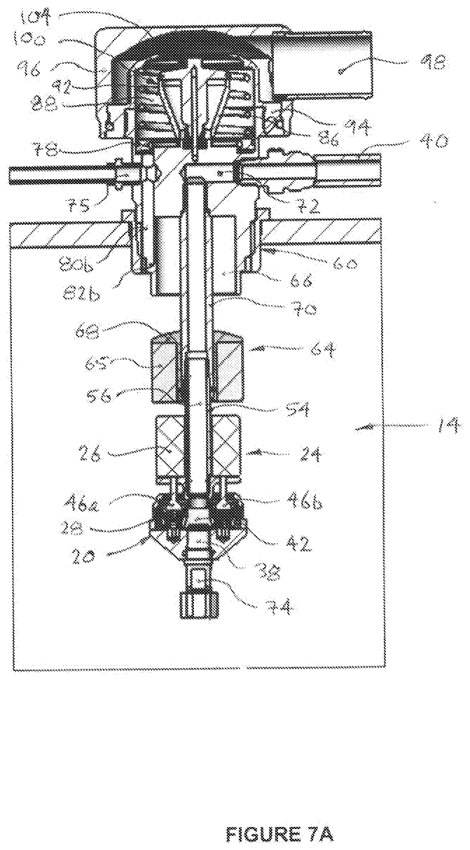

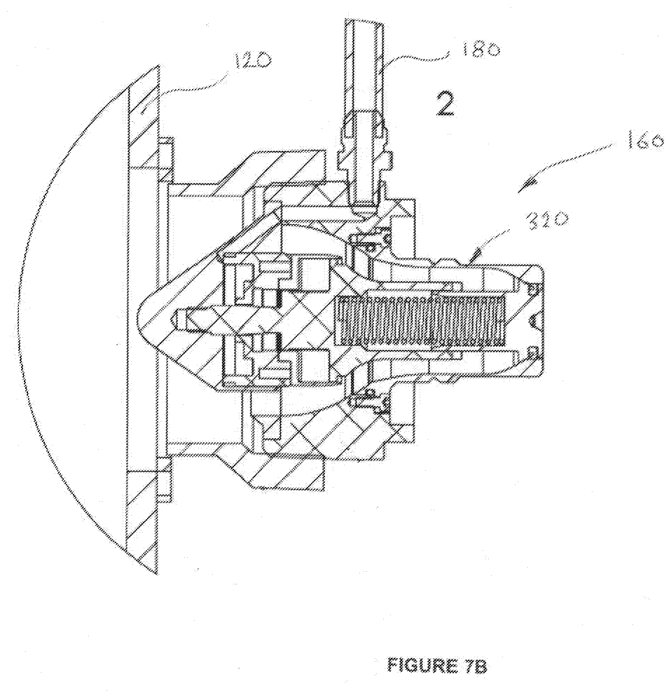

FIG. 6 illustrates an alternative embodiment employing the same tank level sensor 14 (see FIG. 7A) of the preceding embodiment but with it connected via an external pilot line 180 to another flow control valve 160 (see FIG. 7B). For ease of reference and in order to avoid repetition, similar components of this flow control valve 160 have been referenced with the same reference numeral having an additional “0” to the preceding embodiment. For example, the receiver sub-assembly has been designated as 320. The tail coupling 40 is replaced with isolation plug 74 and the tail coupling 40 is fitted to the radial opening 72 for connection to the external pilot line 180. The flow control valve 160 is similar to that disclosed in the applicant's international patent application no. PCT/AU2015/050802 the contents of which are considered to be included herein by this reference.

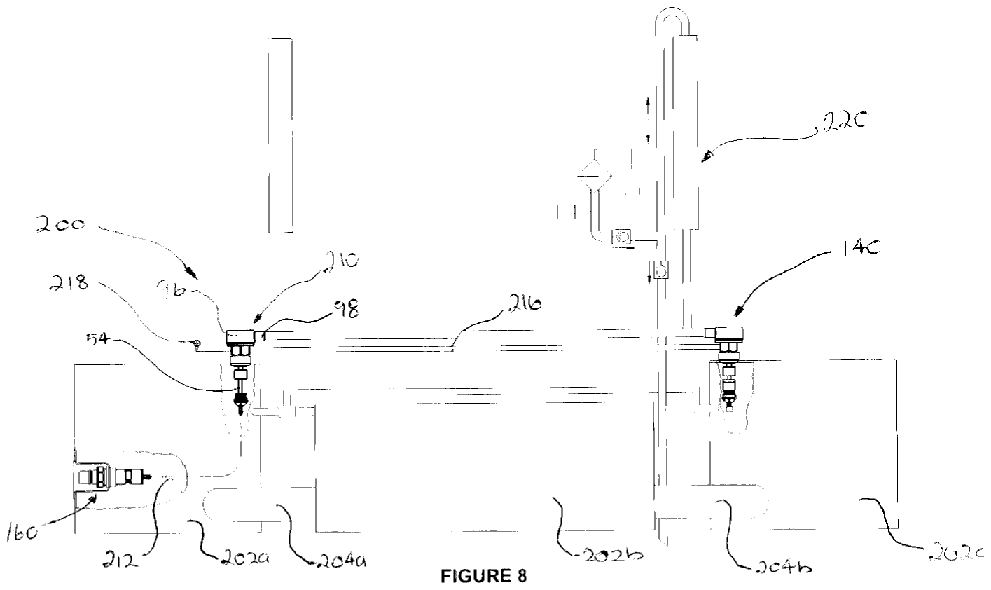

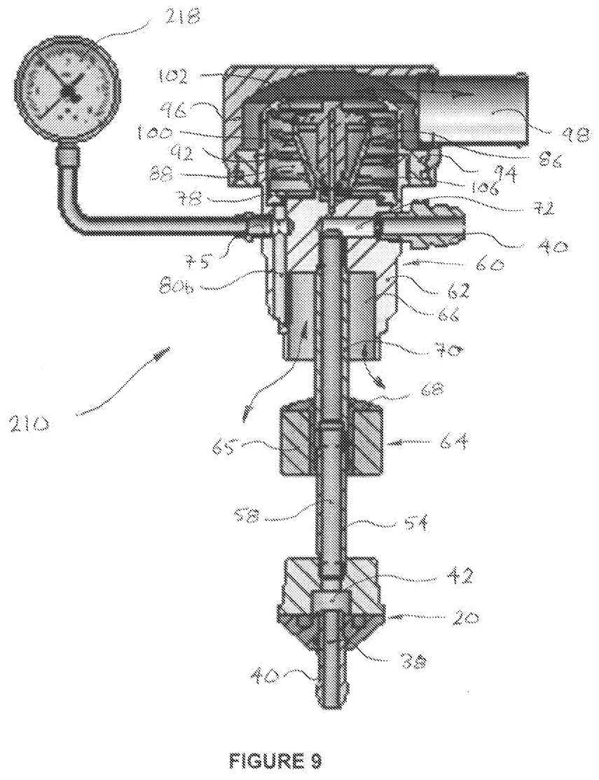

FIGS. 8 and 9 schematically illustrate another aspect of the invention which in this embodiment is a refilling system 200 for three tanks 202a/202b/202c arranged in series with one another. The left hand or upstream tank 202a is connected to the central tank via enlarged pipe 204a and the right hand or downstream tank 202c is connected to the central tank 202b via enlarged pipe 204b. The upstream tank 202a is provided with a flow control valve assembly 160 for filling of all three tanks 202a/b/c. Otherwise, the refilling system 200 also generally comprises:
1. a tank vent assembly 210 mounted to the upstream tank 202a;
2. a tank level sensor 140 mounted to the associated downstream tank 202c, the level sensor 140 arranged to detect a safe fill level in the downstream tank 202c and trigger the flow control valve assembly 160 for closure.

In this embodiment the tank vent assembly 210 is similar in construction to the tank level sensor 14 of the preceding embodiment but without the balance member 26 and associated pilot valve components. The flow control valve assembly 160 thus connects to the tank vent assembly 210 via the tail coupling 40 and an associated upstream pilot line 212 internally of the upstream tank 202a but without bleeding fluid into the upstream tank 202a. The tank vent assembly 210 otherwise provides the same tank vent or breathing capability in conjunction with the integrated pressure relief functionality of the preceding embodiments.

In this aspect the tank level sensor 140 of the refilling system 200 is substantially identical to the preceding embodiment but in this instance is connected to the tank vent assembly 210 via the tail coupling 40′ and an associated downstream and external pilot line 216. The downstream pilot line 216 delivers bleed fluid from the upstream pilot line 212 via the intermediate hollow tube 54 of the tank vent assembly 210. Otherwise, the tank level sensor 140 of the downstream tank 202c is integrated with tank vent/breathing and pressure relief capability in line with the preceding embodiments. In this embodiment the tank vent assembly 210 is fitted with a witness gauge 218 since the upstream tank 202a is most susceptible to pressurisation. The chimney 96 and spout 98 of the tank vent assembly 210 is ported into the corresponding spout of the integrated tank level sensor 140 of the downstream tank 202c and together they connect to a common filter vent arrangement 220.

Now that several preferred embodiments of a tank level sensor and tank overfill protection system have been described it will be apparent to those skilled in the art that they have the following advantages:
1. the tank level sensor can be adapted for either an internal or external pilot line depending on the installation;
2. the balance member need not be of a buoyant construction for flotation like conventional float control valves which are susceptible to damage hindering their floatation and thus operation;
3. the effective fluid level within the tank at which the tank level sensor is actuated can be adjusted to suit a variety of tank applications, for example to cater for differing safe fill level requirements;
4. the tank level sensor can be integrated with tank vent and/or pressure relief assemblies providing this functionality;
5. the tank level sensor can be integrated with a rollover valve sub-assembly preventing the spillage of liquid or fuel in the event of a rollover;
6. the tank level sensor is appropriate for use with a range of flow control valves designed to be coupled to a pilot line for bleed fluid activation;
7. the system can include a diagnostic indicator in the form of a witness gauge which provides an indication of the mode of failure in the event of excessive tank pressurisation;
8. the balance member by relying upon the actuator biasing means for movement can be increased in weight providing a positive opening of the pilot valve once the fluid level drops below the safe fill level;
9. the balance member by not relying upon flotation forces alone to raise it can be constructed of a robust material which does not require shielding or a protective housing and thus can be directly exposed to fluid within the tank being more responsive to liquid levels in the tank.

Those skilled in the art will appreciate that the invention described herein is susceptible to variations and modifications other than those specifically described. For example, the balance member may be constructed from a range of materials including but not limited to solid plastics or polymeric material such as a closed-cell foamed material, and solid or at least partly hollow metals including aluminium alloy and steel. The actuator biasing means is not limited to the pilot compression spring but extends to other biasing means which effect movement of the balance member when it is at least partly submerged in the tank liquid where otherwise in the absence of the biasing means the balance member would not move. The tank level sensor need not include integrated venting and pressure relief features and in its simplest form may solely control closure of a flow control valve via an associated pilot line. The system may incorporate a filtration system to remove contaminants (whether particles or moisture) from atmospheric air entering the tank level sensor, and into the tank. The filtration system may be incorporated into the tank level sensor or be remote from the tank level sensor. All such variations and modifications are to be considered within the scope of the present invention the nature of which is to be determined from the foregoing description.

1-39. (canceled)

40. A tank level sensor comprising:
a valve body including a pilot inlet adapted to couple to a pilot line for controlling closure of a flow control valve associated with the tank;
a pilot valve mounted to the valve body and in liquid communication with the pilot inlet;
a pilot valve actuator operatively coupled to the pilot valve for its opening and closure, the pilot valve actuator including a balance member arranged to cooperate with actuator biasing means, the balance member having a specific gravity relative to liquid within the tank whereby at least part submersion of the balance member provides movement of the balance member relative to the valve body, said movement:
i) only occurring with the influence of the actuator biasing means; and
ii) being effective in closure of the pilot valve for closure of the flow control valve via the pilot line.

41. A tank level sensor as claimed in claim 40 wherein the pilot valve includes a poppet valve having a poppet valve head connected to a valve stem arranged to be contacted by the balance member for opening of the pilot valve, the valve head being in contact with the actuator biasing means which urges the poppet valve closed.

42. A tank level sensor as claimed in claim 40 wherein the actuator biasing means includes a pilot compression spring designed to provide sufficient biasing force to provide movement of the balance member relative to the valve body for:
i) closure of the poppet valve on at least part submersion of the balance member with the biasing force of the compression spring overcoming an apparent weight of the balance member;
ii) opening of the poppet valve when the balance member is not at least part submerged and the weight of the balance member overcomes the biasing force of the compression spring.

43. A tank level sensor as claimed in claim 40 wherein the balance member is slidably mounted to an intermediate member which couples the valve body to the tank, the balance member being directly exposed to fluid within the tank to permit at least part submersion of the balance member at or above a safe fill level for closure of the pilot valve.

44. A tank level sensor as claimed in claim 43 wherein the balance member includes an elongate recess within which the intermediate member locates for sliding movement of the balance member under the influence of the actuator biasing means to effect closure of the pilot valve.

45. A tank level sensor as claimed in claim 44 wherein the balance member is shaped cylindrical and the intermediate member is at least in part shaped complementary to the elongate recess of the cylindrical balance member for its sliding movement.

46. A tank level sensor as claimed in claim 40 wherein the valve body is designed to house the pilot valve and includes the pilot inlet in liquid communication with the pilot valve via a pilot passage formed within said valve body.

47. A tank level sensor as claimed in claim 46 wherein the valve body includes a pilot opening within which the pilot valve seats for closure, the pilot opening in liquid communication with the pilot passage.

48. A tank level sensor as claimed in claim 47 wherein the pilot opening provides discharge of bleed fluid from the pilot line into the tank via the pilot passage with the pilot valve opened.

49. A tank overfill protection system comprising:
a) a tank level sensor comprising:
a valve body including a pilot inlet adapted to couple to a pilot line;
a pilot valve mounted to the valve body and in liquid communication with the pilot inlet;
a pilot valve actuator operatively coupled to the pilot valve for its opening and closure, the pilot valve actuator including a balance member arranged to cooperate with actuator biasing means, the balance member having a specific gravity relative to liquid within the tank whereby at least part submersion of the balance member provides movement of the balance member relative to the valve body, said movement of the balance member:
i) only occurring together with the influence of the actuator biasing means; and
ii) being effective in closure of the pilot valve;
b) a flow control valve adapted to mount to the tank and operatively coupled to the pilot line whereby closure of the pilot valve of the tank level sensor provides pressurised bleed fluid in the pilot line which is effective in promoting closure of the flow control valve.

50. An integrated tank level sensor and venting assembly comprising:
a) a tank level sensor comprising:
a valve body including a pilot inlet adapted to couple to a pilot line for controlling closure of a flow control valve associated with the tank;
a pilot valve mounted to the valve body and in liquid communication with the pilot inlet;
a pilot valve actuator operatively coupled to the pilot valve for its opening and closure, the pilot valve actuator including a balance member arranged to cooperate with actuator biasing means, the balance member having a specific gravity relative to liquid within the tank whereby at least part submersion of the balance member provides movement of the balance member relative to the valve body, said movement of the balance member:
i) only occurring together with the influence of the actuator biasing means; and
ii) being effective in closure of the pilot valve for closure of the flow control valve via the pilot line;
b) a tank vent assembly connected to the tank level sensor, said vent assembly comprising:
a tank vent body adapted to mount to the tank, said vent body including one or more vent passages arranged to permit breathing of gas between the tank and atmosphere;
a tank vent valve coupled to the tank vent body and arranged relative to the vent passages to effect their closure in the event the liquid within the tank exceeds a safe fill level, the tank vent valve thus preventing the discharge of the liquid from the tank via the vent passages.

51. An integrated tank level sensor and venting assembly as claimed in claim 50 wherein the tank vent assembly is configured wherein closure of the vent passages via the tank vent valve causes pressurisation of the tank and subsequently automatic closure of a refilling nozzle associated with the tank.

52. An integrated tank level sensor and venting assembly as claimed in claim 50 also comprising a pressure relief valve sub-assembly operatively coupled to the tank vent assembly and arranged to relieve pressure from the tank, said pressure relief valve sub-assembly including a pressure relief piston arranged under excess pressure to be displaced relative to the tank vent body to expose a pressure relief passageway formed in the tank vent body and arranged to permit pressure relief from within the tank via said relief passageway.

53. An integrated tank level sensor and venting assembly as claimed in claim 52 wherein the pressure relief passageway is separate from the vent passages whereby the pressure relief functions independent of tank breathing.

54. An integrated tank level sensor and venting assembly as claimed in claim 52 wherein the pressure relief valve sub-assembly also includes a tank pressure witness gauge operatively coupled to the tank vent body and in fluid communication with the pressure relief passageway to provide an indication of maximum pressure within the tank.

55. An integrated tank level sensor and venting assembly as claimed in claim 50 further comprising a rollover valve sub-assembly operatively coupled to the pressure relief valve sub-assembly and arranged to prevent discharge of liquid from the tank in the event it is inclined beyond a predetermined rollover angle.

56. A refilling system for multiple tanks, said system comprising:
a) a tank vent assembly associated with an upstream tank, said vent sub-assembly including:
a tank vent body adapted to mount to the tank, said vent body including one or more vent passages arranged to permit breathing of gas between the upstream tank and atmosphere;
a tank vent valve coupled to the tank vent body and arranged relative to the vent passages to effect their closure in the event the liquid within the upstream tank exceeds a safe fill level, the tank vent valve thus preventing the discharge of the liquid from the tank via the vent passages;
b) a pressure relief valve sub-assembly integrated with the tank vent assembly, said pressure relief valve sub-assembly including a pressure relief piston arranged under excess pressure to be displaced relative to the tank vent body to expose a pressure relief passageway formed in the tank vent body and arranged to permit pressure relief from within the upstream tank via said relief passageway;
c) a flow control valve adapted to mount to the upstream tank for filling of said upstream tank, said flow control valve operatively coupled to the tank vent body via a pilot line arranged downstream of the tank vent body to be in bleed fluid communication with a tank level sensor mounted to an associated downstream tank being filled from the upstream tank, said tank level sensor arranged to detect a safe fill level in the downstream tank and trigger the flow control valve for closure via pressurised bleed fluid in the pilot line.

57. A refilling system for multiple tanks as claimed in claim 56 wherein the pilot line connects internally of the upstream tank between the flow control valve and the tank vent body of the upstream tank.

58. A refilling system for multiple tanks as claimed in claim 56 wherein the pilot line connects externally of the upstream tank and downstream tank between the tank vent body of the upstream tank and the tank level sensor of the downstream tank.

59. A refilling system for multiple tanks as claimed in claim 56 wherein the tank level sensor of the downstream tank comprises:
a valve body including a pilot inlet adapted to couple to the pilot line for controlling closure of the flow control valve at the upstream tank;
a pilot valve mounted to the valve body and in liquid communication with the pilot inlet;
a pilot valve actuator operatively coupled to the pilot valve for its opening and closure, the pilot valve actuator including a balance member arranged to cooperate with actuator biasing means, the balance member having a specific gravity relative to liquid within the downstream tank whereby at least part submersion of the balance member provides movement of the balance member relative to the valve body, said movement of the balance member:
i) only occurring together with the influence of the actuator biasing means; and
ii) being effective in closure of the pilot valve for closure of the flow control valve via the pilot line.
